(19) United States
(12) Patent Application Publication
(10) Pub. No.: US 2026/0180289 A1
(43) Pub. Date: Jun. 25, 2026

(54) THUNDER AND LIGHTNING INTERCEPTING APPARATUS

(71) Applicant: FOSHAN SHUNDE LUNJIAO JINDUN LIGHTNING PROTECTION TECHNOLOGY DEVELOPMENT CO., LTD, Foshan, Guangdong (CN)

(72) Inventors: Shaojie YANG, Foshan, Guangdong (CN); Hui YANG, Foshan, Guangdong (CN); Yan YANG, Foshan, Guangdong (CN); Sufang ZHOU, Foshan, Guangdong (CN); Yu HUANG, Foshan, Guangdong (CN)

(73) Assignee: FOSHAN SHUNDE LUNJIAO JINDUN LIGHTNING PROTECTION TECHNOLOGY DEVELOPMENT CO., LTD, Foshan, Guangdong (CN)

(21) Appl. No.: 18/856,898

(22) PCT Filed: Jan. 16, 2023
(86) PCT No.: PCT/CN2023/072325

§ 371 Date: Oct. 15, 2024

(30) Foreign Application Priority Data
Apr. 19, 2022 (CN) 202210410008.X

(51) Int. Cl. H01T 19/04

(52) U.S. Cl. CPC H01T 19/04

(57) ABSTRACT

A thunder and lightning intercepting apparatus. In the present application, a sufficiently long target upward leader can be generated, so as to construct a thunder and lightning discharge channel; and several lightning rods are used to receive overhead lightning strikes and side lightning strikes that are from different directions, so as to intercept the overhead lightning strikes and side lightning strikes, thereby effectively attenuating lightning strike currents and reducing the intensity of a lightning-strike electromagnetic field. Therefore, the present application may be applicable to buildings that need protection against direct lightning strikes and induction lightning strikes, and is particularly applicable for use in systems such as onshore/offshore wind power, high-voltage power transmission, or high-speed rail overhead lines, thus playing a role in effectively intercepting lightning strikes from different directions. Not only is the safety of buildings to be protected improved, but the usage cost is also saved on.

This application claims the priority to Chinese patent application No. 202210410008.X, titled “LIGHTNING INTERCEPTION DEVICE”, filed on Apr. 19, 2022 with the China National Intellectual Property Administration, which is incorporated herein by reference in its entirety.

### FIELD

The present disclosure relates to the technical field of lightning interception, and in particular to a lightning interception device.

### BACKGROUND

In practical applications, progress is made in the research on direct lightning protection with the development of science and technology. At present, lightning conductors are widely used in the world for direct lightning protection. A lightning conductor generally includes a needle-shaped end that is made of a conductive metal material.

Under the action of an electric field of a downward leader of a lightning current, the lightning conductor may sense an upwardly developing upward leader which is stronger than other nonmetallic objects and opposite to a charge polarity of the downward leader. The upward leader is connected with the downward leader, thus a lightning current discharge channel is established. It is found that an average length of the upward leader generated by the lightning conductor is about 50 m. The lightning current discharge channel based on the connection of the upward leader and the downward leader may intercept lightning strikes and provide a safe grounding path for a lightning current, attracting and intercepting lightning current, and thereby preventing protected objects from being damaged by direct lightning strikes.

Relative to the protected object, a movement path of a lightning may include: an overhead movement path and a side movement path. Accordingly, the lightning current includes an overhead lightning current and a side lightning stroke current. However, for overhead lightning clouds, the conventional lightning conductor has poor ability to receive the overhead lightning current or the side lightning current due to that the upward leader generated by the conventional lightning conductor is insufficiently long, that is, the conventional lightning conductor has poor ability to receive an overhead lightning current or a side lightning. Therefore, how to increase a length of an upward leader generated by a lightning interception device to attenuate lightning current and intercept a direct lightning strike and a side lightning strike to improve the lightning interception effect of the lightning interception device is always concerned.

### SUMMARY

To overcome the technical defect of the conventional lightning conductor, a lightning interception device is provided according to the present disclosure to overcome the technical defect of an upward conductance generated by a lightning protection device insufficiently long according to the conventional technology.

A lightning interception device is provided. The lightning interception device includes: multiple lightning rods, an interceptor sphere, a sphere connector, a primary waveguide resonance cavity, a secondary waveguide resonance cavity and a tuner. The lightning rods, the interceptor sphere, the sphere connector, the primary waveguide resonance cavity, the secondary waveguide resonance cavity, and the tuner are made of metal. The lightning rods are connected to a surface of the interceptor sphere in a vertical direction and in a horizontal direction, and the interceptor sphere, the sphere connector, the primary waveguide resonance cavity, the secondary waveguide resonance cavity and the tuner are sequentially connected. The lightning rods are configured to receive a lightning current from the vertical direction and the horizontal direction. The sphere connector is configured to maintain an electrical path between the interceptor sphere and the primary waveguide resonance cavity. The interceptor sphere is configured to uniformly distribute charges transferred from the primary waveguide resonance cavity to the lightning rods. In a case that an intensity of a ground surface electric field reaches a predetermined starting threshold, a variable capacitor arranged in the secondary waveguide resonance cavity is turned on, a charge polarity of the lightning interception device is converted to be same as a charge polarity of the ground surface electric field, and a starting voltage of a resonance circuit of the primary waveguide resonance cavity is adjusted to trigger the resonance circuit of the primary waveguide resonance cavity to perform resonance operation. The resonance circuit is arranged in the primary waveguide resonance cavity, a resonance frequency of the resonance circuit reaches a predetermined frequency under adjustment of the secondary waveguide resonance cavity, a voltage Q times higher than the intensity of the ground surface electric field is generated and transferred to tips of the lightning rods to generate a target upward leader with a predetermined length, and a lightning current discharge channel is formed when a downward leader of the lightning current is connected to the target upward leader to discharge the lightning current to a ground. The tuner is configured to adjust distribution parameters of the primary waveguide resonance cavity and the secondary waveguide resonance cavity.

In an embodiment, in discharging the lightning current, the variable capacitor in the secondary waveguide resonance cavity is configured to isolate a continuous current generated in discharging the lightning current to attenuate the lightning current.

In an embodiment, in discharging the lightning current, the variable capacitor in the secondary waveguide resonance cavity is configured to isolate the continuous current generated in discharging the lightning current to attenuate the lightning current by: in discharging the lightning current, isolating, by the variable capacitor in the secondary waveguide resonance cavity, the continuous current generated in discharging the lightning current; and fully reflecting an electromagnetic wave of the continuous current and converting an electric energy of the continuous current to a heat energy to attenuate the lightning current.

In an embodiment, the primary waveguide resonance cavity further includes an amplitude spectrum selector. The amplitude spectrum selector of the primary waveguide resonance cavity is configured to identify and determine an amplitude spectrum and an energy spectrum of the lightning current based on a double exponential wave feature of the lightning current, so that the primary waveguide resonance cavity attenuates the lightning current based on the amplitude spectrum and the energy spectrum of the lightning current.

In an embodiment, the resonance circuit arranged in the primary waveguide resonance cavity includes a circular single conductor. The circular single conductor includes a transverse electric mode or a transverse magnetic mode. The circular single conductor is configured to increase a voltage multiplication value of the lightning interception device and guide a directional propagation of an electromagnetic wave energy.

In an embodiment, the distribution parameters of the primary waveguide resonance cavity and the secondary waveguide resonance cavity includes: an inductance and a capacitance.

In an embodiment, the lightning interception device further includes a cavity lock. An end of the cavity lock is connected to the secondary waveguide resonance cavity, and another end of the cavity lock is connected to the tuner. The cavity lock is configured to lock the secondary waveguide resonance cavity to isolate the secondary waveguide resonance cavity and the primary waveguide resonance cavity from external air.

In an embodiment, the lightning interception further includes a fastening apparatus. An end of the fastening apparatus is connected to the tuner. The fastening apparatus is configured to fix the lightning interception device to a building to be protected.

In an embodiment, the tuner is a circular metal tube or a circular metal rod having a predetermined length and a predetermined diameter.

As can be seen from the above technical solutions, the lightning rods, the interceptor sphere, the sphere connector, the primary waveguide resonance cavity, the secondary waveguide resonance cavity and the tuner according to the present disclosure are all made of metal, improving the performance of the lightning interception device, draining the lightning current c to the ground, and thereby intercepting the lightning and attenuating the lightning current.

The lightning rods may be configured to receive a lightning current from the vertical direction and the horizontal direction to intercept the lightning. The sphere connector may be configured to maintain an electrical path between the interceptor sphere and the primary waveguide resonance cavity, so that the primary waveguide resonance cavity may transfer charges to the interceptor sphere. The interceptor sphere may be configured to transfer the charges of the primary waveguide resonance cavity to the multiple lightning rods and uniformly distribute the charges. In a case that an intensity of a ground surface electric field reaches a predetermined starting threshold, a variable capacitor arranged in the secondary waveguide resonance cavity may be turned on, a charge polarity of the lightning interception device may be converted to be same as a charge polarity of the ground surface electric field, and a starting voltage of a resonance circuit in the primary waveguide resonance cavity may be adjusted, so that the resonance circuit of the primary waveguide resonance cavity performs resonance operation to generate a predetermined resonance frequency. The resonance circuit is arranged in the primary waveguide resonance cavity, a resonance frequency of the resonance circuit may reach the predetermined frequency under adjustment of the secondary waveguide resonance cavity, so that a voltage Q times higher than the intensity of the ground surface electric field may be generated. The generated voltage Q times higher than the intensity of the ground surface electric field may be transmitted to tips of the lightning rods, then the air around the tips of the multiple lightning rods is ionized, and then a target upward leader with a sufficient length may be generated. Therefore, when a downward leader of the lightning current is connected to the target upward leader, a lightning current discharge channel may be formed by the primary waveguide resonance cavity to effectively discharge the lightning current to a ground. The tuner may be configured to adjust distribution parameters of the primary waveguide resonance cavity and the secondary waveguide resonance cavity to ensure the normal operation of the primary waveguide resonance cavity and the secondary waveguide resonance cavity.

According to the embodiments of the present disclosure, a target upward leader with a sufficient length may be generated to construct a lightning current discharge channel, and multiple lightning rods are used to receive an overhead lightning current and a side lightning current in different directions, thus effectively attenuating the lightning current in different directions and reducing the intensity of the lightning electromagnetic field. Therefore, the lightning interception device according to the present disclosure may be applied to buildings requiring preventing a direct lightning current and an induced lightning current, and particularly to buildings in which a Sea breeze power system, a high-voltage power transmission system, a high-speed railway catenary, or the like operates. The lightning interception device may be independently installed in the building to be protected, effectively intercepting the lightning current from different directions. With the lightning interception device according to the present disclosure, the safety of the building to be protected is improved, and the usage costs are saved.

### BRIEF DESCRIPTION OF THE DRAWINGS

For more clearly illustrating embodiments of the present disclosure or technical solutions in the conventional technology, drawings referred to describe the embodiments or the conventional technology will be briefly described hereinafter. Apparently, the drawings in the following description are only some examples of the present disclosure, and for those skilled in the art, other drawings may be obtained based on these drawings without any creative efforts.

FIG. 1 is a schematic structural diagram of a lightning interception device according to an embodiment of the present disclosure;

FIG. 2 is a schematic diagram of an equivalent circuit of a lightning interception device in a static state according to an embodiment of the present disclosure;

FIG. 3 is a schematic diagram of an equivalent circuit of a lightning interception device when an upward leader is generated according to an embodiment of the present disclosure;

FIG. 4 is a schematic diagram of an equivalent circuit of a lightning interception device when an upward leader is connected to a downward leader of a lightning current to form a lightning current discharge channel according to an embodiment of the present disclosure;

FIG. 5 is a schematic diagram of an equivalent circuit of a lightning interception device in suppressing a continuous current according to an embodiment of the present disclosure;

FIG. 6 is a schematic structural diagram of a lightning interception device according to another embodiment of the present disclosure; and

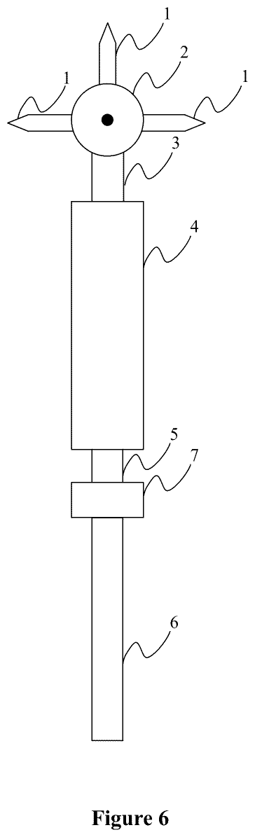

FIG. 7 is a schematic structural diagram of a lightning interception device according to another embodiment of the present disclosure.

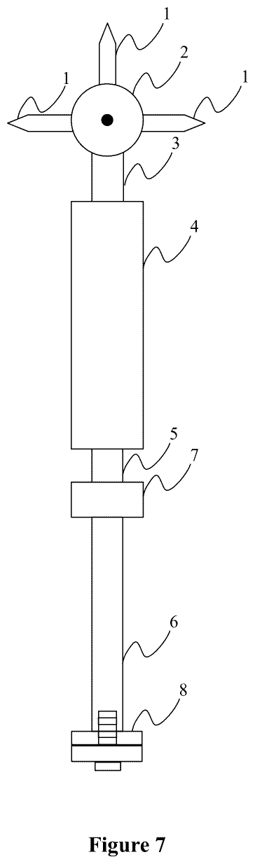

Reference numerals are listed as follows:

| | | | |
|---|---|---|---|
| 1 | lightning rod | 2 | interceptor sphere |
| 3 | sphere connector | | |
| 4 | primary waveguide resonance cavity | | |
| 5 | secondary waveguide resonance cavity | | |
| 6 | tuner | 7 | cavity lock |
| 8 | fastening apparatus | | |

### DETAILED DESCRIPTION OF THE EMBODIMENTS

Technical solutions in the embodiments of the present disclosure are clearly and completely described below in conjunction with the drawings of the embodiments of the present disclosure. Apparently, the embodiments described in the following are only some embodiments of the present disclosure, rather than all of the embodiments. Any other embodiments obtained by those skilled in the art based on the embodiments in the present disclosure without any creative work fall within the protection scope of the present disclosure.

When a lightning strike occurs, there is a lightning discharge process in a thundercloud electric field. The lightning discharge process is a form of electromagnetic wave movement in nature. From an optical perspective, the lightning discharge process may be seen as a flash of white light, which is constrained based on a dispersion theory.

The lightning discharge process may include the following five stages. In a first stage, an upward leader and a downward leader are generated. In a second stage, a first charge return stroke occurs after the upward leader is connected to the downward leader. In a third stage, an arrow leader of the lightning is generated. In a fourth stage, a subsequent charge return stroke occurs, and a continuous current and an M component are generated. In a fifth stage, a last charge return stroke occurs.

(1) The upward leader and the downward leader are generated as follows.

Generally, for the polarity of the internal charges of the thunderstorm, the polarity of the upper charges is positive and the polarity of the lower charges is negative. Usually, the intensity of the electric field of the thunderstorm may range from 50MV to 100MV. In thunderstorm weather, if an air breakdown threshold is reached, a discharge process, which is called as a pre-breakdown process, occurs inside the thunderstorm, providing a condition for forming a downward leader. For the downward leader of the thunderstorm, when the intensity of the electric field at the bottom of the thunderstorm reaches the air breakdown threshold, the air is ionized, a downward moving streamer is formed, and the average distance of downward ionizing the air each time is about 50 m which looks like a cascade in time sequence, so it is called a cascade leader, and also called as a downward leader.

Generally, due to the influence of the electric field at the bottom of the downward leader of the lightning, a needle-shaped end of a lightning arrester induces charges having a polarity opposite to the polarity of the electric field at the bottom of the downward leader. When the intensity of the electric field reaches 10 kV/m, a corona occurs, and an upward corona current (streamer) is generated. The upward corona current is called an upward leader of the lightning. The commonly used lightning arrester may generate an upward leader having an average length of about 50 m. The upward leader and the downward leader of the lightning are restrained by Coulomb forces and move relative to each other, providing a necessary condition for connecting the upward leader with the downward leader.

(2) After the upward leader is connected to the downward leader, the first charge return stroke occurs as follows.

When the downward leader of the lightning is developed to a distance of about 100 m to the needle-shaped end of the lightning arrester, the upward leader may be connected to the downward leader of the lightning. A distance between an end of the upward leader of the lightning and an end of the downward leader of the lightning is called a striking distance. Generally, the striking distance is related to an amplitude of a discharge current of the lightning. After the upward leader of the lightning is connected to the downward leader of the lightning, a discharge channel may be formed in the lightning arrester, and the charges rushes from a ground along the discharge channel towards the cloud to neutralize the charges of the discharge channel and the thunderstorm. The above process is called as a first charge return stroke.

(3) The arrow leader of the lightning is generated as follows.

An arrow leader of the lightning mainly generated after the first charge return stroke. The charge moves along a lightning channel. Due to that the movement path, from a top of the lightning channel to a bottom of the lightning channel, is like an arrow, the generated leader is called as an arrow leader. The arrow leader is generated between the first charge return stroke and the subsequent charge return stroke, serving as a connecting link between the preceding and the following.

(4) The subsequent charge return stroke occurs and the continuous current and the M component are generated as follows.

The subsequent charge return stroke generally occurs after the arrow leader, and the discharge process in the first charge return stroke is repeated continuously. Since each return stroke is a pulse, multiple return strokes form a set of pulse strings with time intervals.

Generally, after establishing the lightning channel from the first charge return stroke, charges exist in the lightning channel for maintaining the lightning channel until the discharge ends. Between multiple subsequent charge return strokes, a pulsating current with a constant moving direction is found at the bottom of the pulses, which is called a continuous current. The continuous current is a low-amplitude current immediately after the return strokes, and is a pulsating direct-current component of the lightning current in the lightning stroke channel.

The continuous current includes several small pulses that are called M components, being one of the three forms of lightning transferring charges to the ground. The three forms of lightning transferring charges to the ground include: a form of return stroke pulse, a form of continuous current, and a form of M component. The continuous current may transfer a large amount of charges, accounting for about 50%, and may cause a severe lightning damage including a thermal effect. According to relevant statistics, 3 to 5 return strokes may occurs in an entire lightning discharge process.

(5) The last charge return stroke occurs as follows.

According to CIGRE2013 “Engineering Applications of Lightning Parameters” of the International Grid conference, it is pointed out that “a peak current of the first charge return stroke is usually 2 to 3 times larger than a peak current of the subsequent charge return stroke, about one-third of ground flashes contain at least one subsequent charge return stroke with a large electric field peak, the peak current of the subsequent charge return stroke should be greater than the peak current of the first charge return stroke in theory, and the subsequent charge return stroke with a peak current greater than the peak current of the first charge return stroke may pose an additional threat to power supply lines and other systems.” The last charge return stroke refers to a final charge return stroke of lightning. There is usually a time interval of 300 ms to 400 ms between a previous charge return stroke and the last charge return stroke, the amplitude of the last charge return stroke is larger than the amplitude of the first charge return stroke, and the parameters of the last charge return stroke is similar to the first charge return stroke.

Due to the limited length of the upward leader generated by the conventional lightning arrester, the conventional lightning arrester cannot effectively attenuate the lightning current and the intensity of the lightning electromagnetic field. Thus, the direct lightning strikes cannot be effectively intercepted. In addition, a protection radius on the ground of the conventional lightning arrester is calculated by using a rolling ball method or a protection angle method. By using the protection angle method, it is calculated that the protection radius on the ground is 1.5 times the height of the lightning arrester and the protection range is a 45° cone angle range. It can be seen that the protection range of the conventional lightning arrester is small, so that it usually cannot to use a single lightning arrester in a building for lightning protection. Generally, multiple lightning arresters are used to form a lightning protection grid or a lightning protection belt to protect the building.

Therefore, a lightning interception device is provided according to the present disclosure, generating a sufficiently long upward leader, effectively attenuating a lightning current, reducing an intensity of a lightning electromagnetic field, and effectively intercept a direct lightning strike and a side lightning strike.

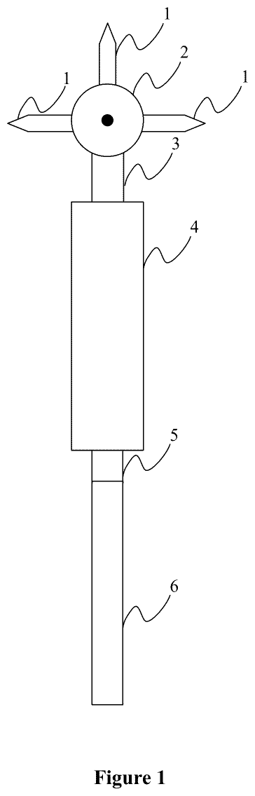

In conjunction with FIG. 1, a lightning interception device according to an embodiment of the present disclosure is introduced below. As shown in FIG. 1, the lightning interception device may include: multiple lightning rods 1, an interceptor sphere 2, a sphere connector 3, a primary waveguide resonance cavity 4, a secondary waveguide resonance cavity 5, and a tuner 6.

The multiple lightning rods 1 are connected with a surface of the interceptor sphere 2 in a vertical direction and a horizontal direction. The interceptor sphere 2, the sphere connector 3, the primary waveguide resonance cavity 4, the secondary waveguide resonance cavity 5 and the tuner 6 are connected in sequence.

The lightning rods 1, the interceptor sphere 2, the sphere connector 3, the primary waveguide resonance cavity 4, the secondary waveguide resonance cavity 5 and the tuner 6 are all made of metal, improving the performance of the lightning interception device to drain the lightning current to a ground, and thereby intercepting the lightning and attenuating the lightning current.

In a thunderstorm weather, in a case that a charged cloud layer appears over a high building, a large amount of charges are induced on the top of the high building. Based on the above description, it can be seen that the lightning current includes the overhead lightning current and the side lightning current. The multiple lightning rods 1 may be configured to receive the overhead lightning current and the side lightning current from different directions, that is, to intercept the overhead lightning and the side lightning. In addition, the ends of the lightning rods 1 are configured as tip ends, so that when electrostatic induction occurs, most of the charges may be gathered at the tip ends of the lightning rods 1. Thus, the lightning rods 1 and the charged cloud layer form a capacitor. Due to the tip ends of the lightning rods 1, the areas of the two plates facing to each other of the capacitor is small, thus the capacitance is small. That is, the lightning rods 1 may hold few charges. However, most of the charges are gathered at the lightning rods 1. Therefore, in a case that the charged cloud layer contains a lot of charges, an air between the lightning rods 1 and the cloud layer is easily to be broken down. Then, a path is formed between the charged cloud layer and the lightning arrester. Since the sphere connector 3 may be configured to maintain an electrical path between the interceptor sphere 2 and the primary waveguide resonance cavity 4, the primary waveguide resonance cavity 4 may transfer charges to the interceptor sphere 2. Thus, the lightning rods 1 are connected to the ground through the interceptor sphere 2, the sphere connector 3, the primary waveguide resonance cavity 4, the secondary waveguide resonance cavity 5 and the tuner 6. Therefore, the lightning rods 1 may lead the charges from the cloud layer into the ground to avoid danger to the high building. Therefore, multiple lightning rods 1 are arranged on the interceptor sphere 2 in the horizontal direction and in the vertical direction to receive the overhead lightning current and the side lightning current along the vertical direction and the horizontal direction, intercepting the overhead lightning strike and the side lightning strike in the vertical direction and in the horizontal direction.

Since multiple lightning rods 1 are used to receive the overhead lightning current and the side lightning current in the vertical direction and the horizontal direction, that is, to intercept the overhead lightning strike and the side lightning strike in the vertical direction and the horizontal direction, it is required for the multiple lightning rods 1 to maintain same charges at tip ends. Therefore, the interceptor sphere 2 may be configured to uniformly distribute the charges transferred from the primary waveguide resonance cavity 4 to the lightning rods 1.

The secondary waveguide resonance cavity 5 is arranged with a variable capacitor. For the variable capacitor, the capacity may be adjusted within a range, and the capacity may be changed by changing relative effective areas of electrode pieces or a distance between the electrode pieces. The variable capacitor is usually used as a tuning capacitor in a radio reception circuit. In a case of no lightning activity, the intensity of the electric field of the ground is equal to the intensity of the electric field in sunny days, and the lightning interception device operates in a static state. In a thunderstorm weather, under the induction of the electric field of the downward leader at the bottom of the center of thunderstorm charges, the surface of the ground is induced with an electric field with a polarity opposite to the polarity of the electric field of the downward leader of thunderstorm, for example, the surface of the ground is induced with an electric field with a positive polarity opposite to the negative polarity of the electric field of the downward leader of thunderstorm. Under the induction of the electric field of the downward leader of thunderstorm, in a case that an intensity of a ground surface electric field reaches a predetermined starting threshold, the variable capacitor of the secondary waveguide resonance cavity 5 may be turned on. After the variable capacitor of the secondary waveguide resonance cavity 5 is turned on, the secondary waveguide resonance cavity 5 may convert a charge polarity of the lightning interception device to be same as a charge polarity of the ground surface electric field based on the charge polarity of the ground surface electric field. A starting voltage of a resonance circuit of the primary waveguide resonance cavity 4 may be adjusted, so that the resonance circuit in the primary waveguide resonance cavity 4 starts to perform resonance operation.

The resonance circuit is arranged in the primary waveguide resonance cavity 4. After the variable capacitor in the secondary waveguide resonance cavity 5 is turned on, the resonance circuit in the primary waveguide resonance cavity 4 starts to perform resonance operation under the adjustment of the secondary waveguide resonance cavity 5. The essence of the resonance operation is a mutual conversion between an electric field energy in a capacitor and a magnetic field energy in an inductor, in which the electric field energy increases and the magnetic field energy decreases or the electric field energy decreases and the magnetic field energy increases, and fully compensation is performed. Under the resonance operation of the resonance circuit, a sum of the electric field energy and the magnetic field energy of the lightning interception device may remain unchanged. After a resonance frequency of the resonance circuit reaches a predetermined frequency, the primary waveguide resonance cavity 4 may generate a voltage Q times higher than the intensity of the ground surface electric field, and may transmit the generated voltage Q times higher than the intensity of the ground surface electric field to tips of the lightning rods 1. In a case that a voltage at the tips of the lightning rods 1 reaches the voltage Q times higher than the intensity of the ground surface electric field, the intensities of the electric fields at the tips of the lightning rods 1 are increased with approaching the downward leader of lightning. After a corona threshold is reached, the air around the tips of the lightning rods 1 may be ionized, and then a corona current is generated. The corona current and a displacement current of the downward leader of the lightning are also called as streamers due to the visible light of the corona current and the displacement current. The corona current, under the action of the electric field of the downward leader of the lightning, moves towards an end of the downward leader of the lightning. Thereby, a target upward leader with a predetermined length may be generated.

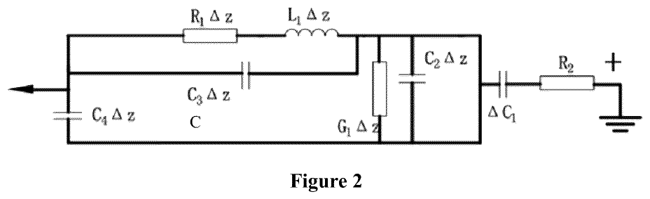

For example, to represents a time instant at which no lightning activity occurs. In a case that the lightning interception device operates in a static state, a static equivalent circuit, as shown in FIG. 2, may be formed by the lightning rods 1, the interceptor sphere 2, the sphere connector 3, the primary waveguide resonance cavity 4, the secondary waveguide resonance cavity 5 and the tuner 6. FIG. 2 shows a schematic diagram of a static equivalent circuit of a lightning interception device in a non-thunderstorm weather.

In FIG. 2, AZ represents a line element, ΔC₁ represents a variable capacitance, C₂ΔZ represents a cavity capacitance, G₁ΔZ represents a cavity conductance, L₁ΔZ represents an inductance, R₁ΔZ represents a resistance, C₃ΔZ represents a capacitance, C₄ΔZ represents a capacitance, and R₂ represents a down conductor impedance.

Generally, in a case of non-thunderstorm weather, the lightning interception device operates in a static state. The electric field of the ground is equivalent to an electric field in sunny days, with an intensity of about 100 V/m, which is not enough to start the equivalent circuit. The primary waveguide resonance cavity 4 and the secondary waveguide resonance cavity 5 operate in a static state. In this case, a current i of the primary waveguide resonance cavity 4 is equal to 0, an electric field E of a downward leader is equal to 0, an upward leader i is equal to 0, and an atmospheric impedance Z₀ is equal to 120πΩ.

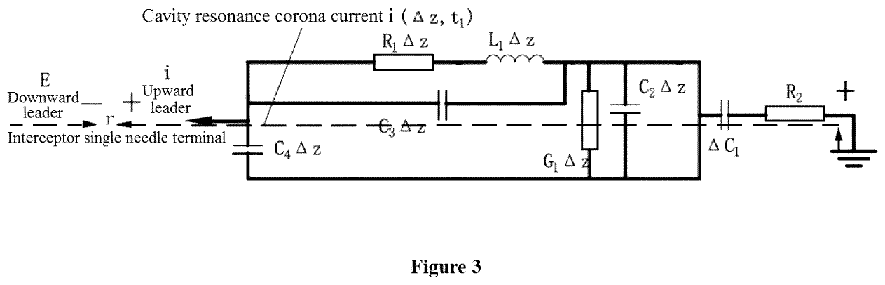

t1 represents a time instant at which a lightning activity occurs. An equivalent circuit, as shown in FIG. 3, may be formed by the lightning rods 1, the primary waveguide resonance cavity 4, the secondary waveguide resonance cavity 5 and the tuner 6. FIG. 3 shows a process of a primary waveguide resonance cavity 4 generating a target upward leader.

In FIG. 3, ΔZ represents a line element, ΔC₁ represents a variable capacitance, C₂ΔZ represents a cavity capacitance, G₁ΔZ represents a cavity conductance, L₁ΔZ represents an inductance, R₁ΔZ represents a resistance, C₃ΔZ represents a capacitance, C₄ΔZ represents a capacitance, R₂ represents a down conductor impedance, and r represents a striking distance of a lightning current above the tips of the lightning rods 1. In a case that r is not equal to zero, the target upward leader has not been connected to the downward leader generated by the lightning current.

An intensity of an electric field of the downward leader generated by the lightning current is expressed as E=Eₘ sin(ωt₁+φ), and a corona current of the target upward leader generated by the primary waveguide resonance cavity 4 is expressed as I=Iₘ sin(ωt₁+φ).

In FIG. 3, a dashed arrow to the left side represents a flow direction of the target upward leader generated by the primary waveguide resonance cavity 4, and a dashed arrow to the right side represents a flow direction of the downward leader generated by the lightning current.

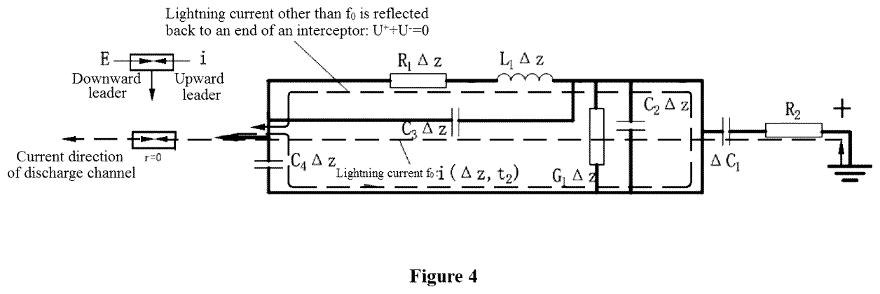

In a case that r is equal to zero, the target upward leader is connected to the downward leader of the lightning current, and then a lightning current discharge channel may be formed. In this case, an equivalent circuit, formed by the lightning rods 1, the interceptor sphere 2, the sphere connector 3, the primary waveguide resonance cavity 4, the secondary waveguide resonance cavity 5 and the tuner 6, is shown in FIG. 4.

In FIG. 4, ΔZ represents a line element, ΔC₁ represents a variable capacitance, C₂ΔZ represents a cavity capacitance, G₁ΔZ represents a cavity conductance, L₁ΔZ represents an inductance, R₁ΔZ represents a resistance, C₃ΔZ represents a capacitance, C₄ΔZ represents a capacitance, R₂ represents a down conductor impedance, r represents a striking distance of the lightning current above the tips of the lightning rods 1, and f₀ represents a predetermined resonance frequency generated by the primary waveguide resonance cavity 4.

t₂ represents a time instant at which the downward leader of the lightning current is connected to the target upward leader generated by primary the waveguide resonance cavity 4. At t₂, the downward leader of the lightning current is connected to the target upward leader, a striking distance r is equal to Om, and an air impedance Z₀ is equal to 0Ω. The lightning discharge current is discharged to the ground after passing through the resonance circuit of the primary waveguide resonance cavity 4 and the down conductor impedance R₂. A lightning current multi-pulse discharge process mainly includes: a first charge return stroke, an arrow leader, a subsequent charge return stroke, and a last charge return stroke. Based on Fourier series analysis and transformation, each lightning current pulse contains multiple different frequency components and amplitude features. An energy spectrum distribution may be obtained by using a Parseval energy equation.

After the target upward leader is connected to the downward leader of the lightning current at t₂, the charge first return stroke occurs. A frequency component, that meets a resonance frequency bandwidth limit of the primary waveguide resonance cavity 4, among the various frequency components of the pulse current of the first charge return stroke passes through the down conductor impedance R₂, ΔC₁ and the resonance circuit of the primary waveguide resonance cavity 4 from the ground, and then neutralizes charges of the lightning current discharge channel and the thunderstorm along the established lightning current discharge channel. The movement path is shown by dashed lines in FIG. 4. For a frequency component that does not meet the resonance frequency bandwidth limit of the primary waveguide resonance cavity 4, when the frequency component passes through the primary waveguide resonance cavity 4, the primary waveguide resonance cavity 2 presents a high impedance, so that the frequency component is attenuated in primary the waveguide resonance cavity 4. In addition, based on a transmission line principle, the frequency component, that does not meet the resonance frequency bandwidth limit of the primary waveguide resonance cavity 4, may be reflected in the primary waveguide resonance cavity 4, then electric energy is converted to heat energy, and then the amplitude of the lightning current is further attenuated.

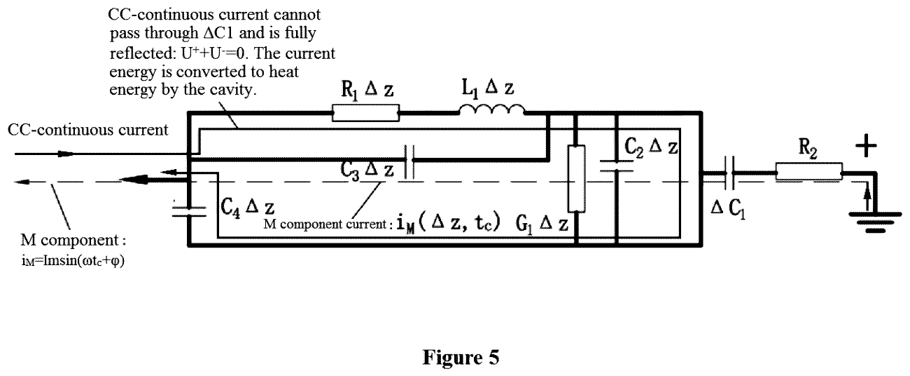

In a case that the lightning current passes through the constructed lightning current discharge channel, an equivalent circuit, formed by the lightning rods 1, the interceptor sphere 2, the sphere connector 3, the primary waveguide resonance cavity 4, the secondary waveguide resonance cavity 5 and the tuner 6, is shown in FIG. 5.

Based on the above description, it can be seen that when the lightning current is discharged in multiple pulses, a continuous current having an instant current direction exists. A small pulse in the continuous current is called an M component. As can be seen from FIG. 5, the variable capacitor ΔC₁ in the secondary waveguide resonance cavity performs isolation on a direct current. In discharging the lightning current, the continuous current and the M component enter into the primary waveguide resonance cavity 4 and the secondary waveguide resonance cavity 5 in the pulse discharge process. After the continuous current enters into the primary waveguide resonance cavity 4 and the secondary waveguide resonance cavity 5, the continuous current may not pass through ΔC₁ and is totally reflected in the secondary waveguide resonance cavity 5. The reflection path is shown by a circular dashed line in FIG. 5. In the total reflection process, the electric energy of the lightning current may be converted to heat energy to greatly attenuate the lightning current, theoretically reaching over 50%. The M component may pass through ΔC₁ like other discharge pulses.

Based on a high voltage test, it shows that the lightning interception device may generate a corona current 46.55 us earlier than the conventional lightning arrester. That is, the length of the target upward leader generated according to the present disclosure exceeds at least 50 meters.

For example, a Q value of the resonance circuit in the primary waveguide resonance cavity 4 may be set to 37.

After generating the target upward leader having the predetermined length, the target upward leader is still not connected to the downward leader of the lightning current. Since the corona current is transmitted from the ground to the tips of the lightning rods 1 after being resonated by the resonance circuit of the primary waveguide resonance cavity 4 and the corona current is generated after ionizing the air around the tips, the corona current moves towards the end of the downward leader in the air under the action of the electric field of the downward leader of the lightning current. Thus, at both ends of the striking distance above the tips of the lightning rods 1, the polarity of the electric field of the downward leader of the lightning current is negative and the electric field is downward. The polarity of the electric field of the target upward leader is positive and the electric field is upward. When the downward leader of the lightning current is connected to the target upward leader, a lightning current discharge channel may be formed, attenuating the lightning current and discharging the lightning current to the ground.

The tuner 6 is connected to the secondary waveguide resonance cavity 5, and may be configured to adjust distribution parameters, such as a capacitance and an inductance, of the primary waveguide resonance cavity 4 and the secondary waveguide resonance cavity 5, ensuring the normal operation of the primary waveguide resonance cavity 4 and the secondary waveguide resonance cavity 5.

According to the embodiments of the present disclosure, a target upward leader with a sufficient length may be generated to construct a lightning current discharge channel, and multiple lightning rods are used to receive an overhead lightning current and a side lightning current in different directions, thus effectively attenuating the lightning current in different directions and reducing the intensity of the lightning electromagnetic field. Therefore, the lightning interception device according to the present disclosure may be applied to buildings requiring preventing a direct lightning current and an induced lightning current, and particularly to buildings in which a Sea breeze power system, a high-voltage power transmission system, a high-speed railway catenary, or the like operates, effectively intercepting the lightning current from different directions. With the lightning interception device according to the present disclosure, the safety of the building to be protected is improved, and the usage costs are saved.

Based on the technical solutions described above, it can be seen that the secondary waveguide resonance cavity 5 according to the present disclosure may be configured to attenuate the lightning current, which is described in detail below.

Based on the above description, it can be seen that in discharging the lightning current with multiple pulses, a component, which is called as a continuous current, having an instant current direction may exist, and the small pulse in the continuous current is called as M component.

A variable capacitor is arranged in the secondary waveguide resonance cavity 5, and the variable capacitor performs isolation on a direct current. In discharging the lightning current, some continuous currents and M components are generated, and then the continuous currents and M components enter into the secondary waveguide resonance cavity 5. After the continuous current enters into the secondary waveguide resonance cavity 5, the variable capacitor in the secondary waveguide resonance cavity 5 may isolate the continuous current to prevent the continuous current from passing through the variable capacitor in the secondary waveguide resonance cavity 5. Based on the transmission line principle, a frequency component in the continuous current, that does not meet a bandwidth limit of the primary waveguide resonance cavity 4, may be fully reflected in the secondary waveguide resonance cavity 5. In fully reflecting the continuous current, the electric energy of the continuous current may be converted to heat energy, further attenuating the amplitude of the frequency component of the pulse current in the first charge return stroke.

From the technical solutions described above, it can be seen that the secondary waveguide resonance cavity 5 according to the present disclosure may isolate the continuous current generated in discharging the lightning current, attenuating the lightning current, such as a pulse current, to a certain extent. Thus, the intensity of the lightning electromagnetic field may be effectively reduced, and the lightning current is effectively intercepted.

In practical applications, the primary waveguide resonance cavity 4 further includes an amplitude spectrum selector 41. The amplitude spectrum selector 41 of the primary waveguide resonance cavity 4 is configured to identify and determine an amplitude spectrum and an energy spectrum of the lightning current based on a double exponential wave feature of the lightning current in discharging the lightning current to attenuate the lightning current.

From the above description, it can be seen that in discharging the lightning current, multiple lightning current pulses may be generated, and each of the lightning current pulses contains multiple different frequency components and amplitude features.

When the lightning current passes through the primary waveguide resonance cavity 4, the amplitude spectrum selector 41 in the primary waveguide resonance cavity 4 may identify and determine an amplitude spectrum and an energy spectrum of the lightning current based on a double exponential wave feature of the lightning current.

In discharging the lightning current, after the upward leader is connected to the downward leader to form the lightning current discharge channel, a first charge return stroke occurs. The charges rushes from the ground to the cloud along the discharge channel to neutralize the charges in the discharge channel and the thunderstorm. Since the energy spectrum distribution of the lightning current has been identified, an amplitude spectrum and an energy spectrum of the lightning current may be determined. Therefore, a frequency component, among various frequency components of a pulse current in the first charge return stroke in discharging the lightning current and meeting a resonance frequency bandwidth limit of the primary waveguide resonance cavity 4, passes through the resonance circuit in the primary waveguide resonance cavity 4 from the ground, and then neutralizes the charges of the lightning current discharge channel and the thunderstorm along the established lightning current discharge channel. For a frequency component that does not meet the resonance frequency bandwidth limit of the resonance circuit of the primary waveguide resonance cavity 4, when the frequency component passes through the primary waveguide resonance cavity 4, the primary waveguide resonance cavity 4 presents a high impedance, so that the frequency component that does not meet the resonance frequency bandwidth limit of the resonance circuit in the primary waveguide resonance cavity 4 is attenuated. In addition, based on the transmission line principle, the frequency component, that does not meet the resonance frequency bandwidth limit of the resonance circuit in the primary waveguide resonance cavity 4, may be reflected in the primary waveguide resonance cavity 4, and the electric energy is converted to heat energy, so that the amplitude of the frequency component that does not meet the resonance frequency bandwidth limit of the resonance circuit in the primary waveguide resonance cavity 4 may be further attenuated.

From the technical solutions described above, it can be seen that the amplitude spectrum selector 41 in the primary waveguide resonance cavity 4 according to the present disclosure may identify and determine the amplitude spectrum and the energy spectrum of the lightning current based on the double exponential wave feature of the lightning current. Thus, the frequency component that does not meet the resonance frequency bandwidth limit of the resonance circuit in the primary waveguide resonance cavity 4 may be be attenuated. In addition, the amplitude of the frequency component that does not meet the resonance frequency bandwidth limit of the resonance circuit in the primary waveguide resonance cavity 4 may be further attenuated.

As can be seen from the above description, the resonance circuit is arranged in the primary waveguide resonance cavity 4 according to the present disclosure. In practical applications, the resonance circuit may include a circular single conductor 42, that is, a circular single conductor waveguide.

The circular single conductor 42 may include a transverse electric mode or a transverse magnetic mode.

For the transverse magnetic mode, a magnetic field is completely distributed in a cross section perpendicular to a propagation direction of an electromagnetic wave, and an electric field has a component in a propagation direction. The transverse magnetic mode is recorded as a TM mode.

For a mode in which an electric field is polarized only in a y direction parallel to a waveguide interface, and the direction of the electric field, perpendicular to a propagation direction z of light, is transverse, this mode is called a transverse electric mode, that is, a TE mode.

In the circular single conductor 42 of the resonance circuit in the primary waveguide resonance cavity 4, the transverse electric mode or the transverse magnetic mode is used to generate the predetermined resonance frequency. Therefore, with the circular single conductor 42, a voltage multiplication value of the lightning interception device may be increased and a directional propagation of an electromagnetic wave energy may be guided.

As can be seen from the above description, the resonance circuit arranged in the primary waveguide resonance cavity 4 may include the circular single conductor 42 according to the present disclosure. The circular single conductor 42 may include the transverse electric mode or the transverse magnetic mode to increase the voltage multiplication value of the lightning interception device and guide the directional propagation of the electromagnetic wave energy.

In practical applications, the lightning interception device according to the present disclosure may further include a cavity lock 7. FIG. 2 shows a schematic structural diagram of a lightning interception device according to the present disclosure.

An end of the cavity lock 7 is connected to the secondary waveguide resonance cavity 5, and another end of the cavity lock 7 is connected to the tuner 6.

The cavity lock 7 may be configured to lock the secondary waveguide resonance cavity 5 to isolate the secondary waveguide resonance cavity 5 and the primary waveguide resonance cavity 4 from external air, protecting the secondary waveguide resonance cavity 5 and the primary waveguide resonance cavity 4 from corrosion, and thereby ensuring the normal operation of the secondary waveguide resonance cavity 5 and the primary waveguide resonance cavity 4.

Based on the technical solutions described above, it can be seen that the cavity lock 7 according to the present disclosure may isolate the secondary waveguide resonance cavity 5 and the primary waveguide resonance cavity 4 from the external air, protecting the secondary waveguide resonance cavity 5 and the primary waveguide resonance cavity 4 from corrosion, and thereby ensuring the normal operation of the secondary waveguide resonance cavity 5 and the primary waveguide resonance cavity 4.

In practical applications, the lightning interception device according to the present disclosure may further include a fastening apparatus 8.

An end of the fastening apparatus 8 is connected to the tuner 6.

The fastening apparatus 8 may be configured to fix the lightning interception device to a building to be protected.

As can be seen from the above description, the fastening apparatus 8 according to the present disclosure may be configured to fix the lightning interception device to the building to be protected. Therefore, the lightning interception device may be independently installed in the building to be protected to effectively intercept the lightning current, improving the safety of the building to be protected and saving the use cost for intercepting the lightning current.

As can be seen from the above description, the tuner 6 may adjust the distribution parameters, such as the capacitance and the inductance, of the primary waveguide resonance cavity 4 and the secondary waveguide resonance cavity 5, ensuring the normal operation of the primary waveguide resonance cavity 4 and the secondary waveguide resonance cavity 5.

In practical applications, tuners with different lengths and diameters have different parameters. In order to intercept the lightning current by the lightning interception device, tuners with different lengths and diameters may be selected. The parameters of the primary waveguide resonance cavity 4 and the secondary waveguide resonance cavity 5 may be slightly affected by the tuner 6. Therefore, the tuner 6 may be configured as a circular metal tube or a circular metal rod with a predetermined length and a predetermined diameter according to actual requirements.

For example, the tuner 6 may be configured as a circular metal tube or a circular metal rod with a length ranging from 200 mm to 260 mm and a diameter ranging from 25 mm to 28 mm to ensure that the tuner 6 has an inherent inductance L ranging from 0.5 μH to 0.8 μH and an inherent capacitance C ranging from 500 PF to 800 PF.

As can be seen from the technical solutions described above, the tuner 6 according to the present disclosure may be configured as a circular metal tube or a circular metal rod with different lengths and diameters according to requirements, effectively adjusting the distribution parameters, such as the capacitance and the inductance, of the primary waveguide resonance cavity 4 and the secondary waveguide resonance cavity 5, thereby ensuring the normal operation of the primary waveguide resonance cavity 4 and the secondary waveguide resonance cavity 5.

Finally, it should be further noted that a relation term such as “first” and “second” herein is only used to distinguish one entity or operation from another entity or operation, and does not necessarily require or imply that there is an actual relation or sequence between these entities or operations. Moreover, the terms “comprise”, “include”, or any other variants thereof are intended to encompass a non-exclusive inclusion, such that the process, method, article, or device including a series of elements includes not only those elements but also those elements that are not explicitly listed, or the elements that are inherent to such process, method, article, or device. Unless explicitly limited, the statement “including a . . . ” does not exclude the case that other similar elements may exist in the process, method, article or device other than enumerated elements.

The embodiments in this specification are described in a progressive way, each of which emphasizes the differences from others, and for the same or similar parts among the embodiments, one may refer to description of other embodiments.

Based on the above description of the disclosed embodiments, those skilled in the art can implement or carry out the present disclosure. Various modifications made to these embodiments are apparent to those skilled in the art. The general principle defined herein may be implemented in other embodiments without departing from the spirit or scope of the present disclosure. Various embodiments may be combined with each other. Therefore, the present disclosure shall not be limited to the embodiments described herein, but have the widest scope that complies with the principle and novelty disclosed in this specification.

1. A lightning interception device, comprising:
a plurality of lightning rods;
an interceptor sphere;
a sphere connector;
a primary waveguide resonance cavity;
a secondary waveguide resonance cavity; and
a tuner, wherein
the plurality of lightning rods, the interceptor sphere, the sphere connector, the primary waveguide resonance cavity, the secondary waveguide resonance cavity and the tuner are made of metal;
the lightning rods are connected to a surface of the interceptor sphere in a vertical direction and in a horizontal direction, and the interceptor sphere, the sphere connector, the primary waveguide resonance cavity, the secondary waveguide resonance cavity and the tuner are sequentially connected;
the lightning rods are configured to receive a lightning current from the vertical direction and the horizontal direction;
the sphere connector is configured to maintain an electrical path between the interceptor sphere and the primary waveguide resonance cavity;
the interceptor sphere is configured to uniformly distribute charges transferred from the primary waveguide resonance cavity to the plurality of lightning rods;
in a case that an intensity of a ground surface electric field reaches a predetermined starting threshold, a variable capacitor arranged in the secondary waveguide resonance cavity is turned on, a charge polarity of the lightning interception device is converted to be the same as a charge polarity of the ground surface electric field, and a starting voltage of a resonance circuit of the primary waveguide resonance cavity is adjusted to trigger the resonance circuit of the primary waveguide resonance cavity to perform resonance operation;
the resonance circuit is arranged in the primary waveguide resonance cavity, a resonance frequency of the resonance circuit reaches a predetermined frequency under adjustment of the secondary waveguide resonance cavity, a voltage Q times higher than the intensity of the ground surface electric field is generated and transmitted to tips of the lightning rods to generate a target upward leader with a predetermined length, and a lightning current discharge channel is formed when a downward leader of the lightning current is connected to the target upward leader to discharge the lightning current to a ground; and
the tuner is configured to adjust distribution parameters of the primary waveguide resonance cavity and the secondary waveguide resonance cavity.

2. The lightning interception device according to claim 1, wherein in discharging the lightning current, the variable capacitor in the secondary waveguide resonance cavity is configured to isolate a continuous current generated in discharging the lightning current to attenuate the lightning current.

3. The lightning interception device according to claim 2, wherein in discharging the lightning current, the variable capacitor in the secondary waveguide resonance cavity is configured to isolate the continuous current generated in discharging the lightning current to attenuate the lightning current by:
in discharging the lightning current, isolating, by the variable capacitor in the secondary waveguide resonance cavity, the continuous current generated in discharging the lightning current; and
fully reflecting an electromagnetic wave of the continuous current and converting an electric energy of the continuous current to a heat energy to attenuate the lightning current.

4. The lightning interception device according to claim 1, wherein
the primary waveguide resonance cavity further comprises an amplitude spectrum selector; and
the amplitude spectrum selector of the primary waveguide resonance cavity is configured to identify and determine an amplitude spectrum and an energy spectrum of the lightning current based on a double exponential wave feature of the lightning current, wherein the primary waveguide resonance cavity attenuates the lightning current based on the amplitude spectrum and the energy spectrum of the lightning current.

5. The lightning interception device according to claim 1, wherein
the resonance circuit arranged in the primary waveguide resonance cavity comprises a circular single conductor;
the circular single conductor comprises a transverse electric mode or a transverse magnetic mode; and
the circular single conductor is configured to increase a voltage multiplication value of the lightning interception device and guide a directional propagation of an electromagnetic wave energy.

6. The lightning interception device according to claim 1, wherein the distribution parameters of the primary waveguide resonance cavity and the secondary waveguide resonance cavity comprise: an inductance and a capacitance.

7. The lightning interception device according to claim 1, further comprising a cavity lock, wherein
an end of the cavity lock is connected to the secondary waveguide resonance cavity, and another end of the cavity lock is connected to the tuner; and
the cavity lock is configured to lock the secondary waveguide resonance cavity to isolate the secondary waveguide resonance cavity and the primary waveguide resonance cavity from external air.

8. The lightning interception device according to claim 1, further comprising a fastening apparatus, wherein
an end of the fastening apparatus is connected to the tuner; and
the fastening apparatus is configured to fix the lightning interception device to a building to be protected.

9. The lightning interception device according to claim 1, wherein the tuner is a circular metal tube or a circular metal rod having a predetermined length and a predetermined diameter.
